(19) United States
(12) Patent Application Publication
(10) Pub. No.: US 2007/0001598 A1
(43) Pub. Date: Jan. 4, 2007

(54) Plasma display panel and method of manufacturing the same

(75) Inventor: Wootae Kim, Yongin-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/478,139

(22) Filed: Jun. 30, 2006

(30) Foreign Application Priority Data
Jul. 1, 2005 (KR) 10-2005-0059434

(51) Int. Cl. H01J 1/62

(52) U.S. Cl. 313/509

(57) ABSTRACT

A plasma display panel is disclosed. The plasma display panel includes a substrate, a fist electrode and a second electrode formed on the substrate, and a dielectric layer formed on the first electrode and the second electrode. The dielectric layer has at least one groove formed between the first electrode and the second electrode. A slope of the side of the groove ranges from 0.2 to 1.5. A horizontal distance ranging from an end of a first transparent electrode of the first electrode or an end of a second transparent electrode of the second electrode to an end of a bottom surface of the groove ranges from 10 μm to 100 μm. The depth of the groove ranges from 5 μm to 30 μm.

This Non-provisional application claims priority under 35 U.S.C. § 119(a) on Patent Application No. 10-2005-0059434 filed in Korea on Jul. 1, 2005 the entire contents of which are hereby incorporated by reference.

### BACKGROUND OF THE INVENTION

1. Field of the Invention

This document relates to a plasma display panel and a method of manufacturing the plasma display panel.

2. Description of the Background Art

Each of cells of a plasma display panel is filled with an inert gas containing a main discharge gas such as neon (Ne), helium (He) or a Ne-He gas mixture and a small amount of xenon (Xe). When a high frequency voltage is supplied to electrodes of the plasma display panel, the inert gas within the cells generates vacuum ultraviolet rays. The vacuum ultraviolet rays emit a phosphor formed between barrier ribs such that the image is displayed.

A driving signal is supplied to the electrodes of the plasma display panel. The supply of the driving signal generates a reset discharge, an address discharge and a sustain discharge within discharge cells of the plasma display panel. The reset discharge is generated to uniformly form wall charges within the discharge cells. The address discharge is generated to select a discharge cell where light will be emitted. The sustain discharge is generated to emit light in the selected discharge cell. When the sustain discharge is generated within the discharge cell, the inert gas within the discharge cell generates vacuum ultraviolet rays. The vacuum ultraviolet rays emit the phosphor formed within the discharge cell such that the image is displayed.

A distance between the electrodes of the plasma display panel affects a firing start voltage and discharge efficiency of the plasma display panel. Accordingly, the plasma display panel, in which the distance between the electrodes of the plasma display panel is optimized, is required.

### SUMMARY OF THE INVENTION

According to an aspect, there is provided a plasma display panel comprising a substrate, a first electrode and a second electrode formed on the substrate, a distance between the first electrode and the second electrode ranging 10 μm to 200 μm, and a dielectric layer formed on the first electrode and the second electrode, wherein a first distance ranging from the substrate between the first electrode and the second electrode to the surface of the dielectric layer is different from a second distance ranging from the substrate, on which at least one of the first electrode and the second electrode is formed, to the surface of the dielectric layer.

According to another aspect, there is provided a plasma display panel comprising a substrate, a first electrode and a second electrode formed on the substrate, a distance between the first electrode and the second electrode ranging 10 μm to 200 μm, and a dielectric layer, formed on the first electrode and the second electrode, comprising at least one groove formed between the first electrode and the second electrode.

According to still another aspect, there is provided a plasma display panel comprising a substrate, a first electrode and a second electrode formed on the substrate, and a dielectric layer, formed on the first electrode and the second electrode, comprising at least one groove formed between the first electrode and the second eleccode, wherein a slope of the side of the groove ranges from 0.2 to 1.5, a horizontal distance ranging from an end of a first transparent electrode of the first electrode or an end of a second transparent electrode of the second electrode to an end of a bottom surface of the groove ranges from 10 μm to 100 μm, and the depth of the groove ranges from 5 μm to 30 μm.

According to yet still another aspect, there is provided a method of manufacturing a plasma display panel comprising forming a first electrode and a second electrode on a substrate, forming a dielectric layer on the first electrode and the second electrode, and forming at least one groove on the dielectric layer between the first electrode and the second electrode.

### BRIEF DESCRIPTION OF THE DRAWINGS

The embodiment of the invention will be described in detail with reference to the following drawings in which like numerals refer to like elements.

FIG. 1 illustrates a plasma display panel according to an embodiment of the present invention;

FIG. 2 is a cross-sectional view of a front panel of the plasma display panel according to the embodiment of the present invention;

FIGS. 3a and 3b illustrate a comparison between discharge paths of the plasma display panel depending on whether a groove is or not formed in the plasma display panel according to the embodiment of the present invention;

FIG. 4 is a cross-sectional view of a front panel of a plasma display panel according to another embodiment of the present invention; and

FIGS. 5a to 5f illustrate processes for manufacturing the front panel of the plasma display panel according to the embodiments of the present invention.

### DETAILED DESCRIPTION OF PREFERRED EMBODIMENTS

Embodiments of the present invention will be described in a more detailed manner with reference to the drawings.

A plasma display panel according to embodiments of the present invention comprises a substrate, a first electrode and a second electrode formed on the substrate, a distance between the first electrode and the second electrode ranging 10 μm to 200 μm, and a dielectric layer formed on the first electrode and the second electrode. A first distance ranging from the substrate between the first electrode and the second electrode to the surface of the dielectric layer is different from a second distance ranging from the substrate, on which at least one of the first electrode and the second electrode is formed, to the surface of the dielectric layer.

The first distance may be less than the second distance.

A plasma display panel according to the embodiments of the present invention comprises a substrate, a first electrode and a second electrode formed on the substrate, a distance between the first electrode and the second electrode ranging 10 μm to 200 μm, and a dielectric layer, formed on the first electrode and the second electrode, comprising at least one groove formed between the first electrode and the second electrode.

A slope of the side of the groove may range from 0.2 to 1.5.

The first electrode may comprise a first transparent electrode, and the second electrode may comprise a second transparent electrode. A horizontal distance ranging from an end of the first transparent electrode or an end of the second transparent electrode to an end of a bottom surface of the groove may range from 10 μm to 100 μm.

The depth of the groove may range from 5 μm to 30 μm.

A plasma display panel according to the embodiments of the present invention comprises a substrate, a first electrode and a second electrode formed on the substrate, and a dielectric layer, formed on the first electrode and the second electrode, comprising at least one groove formed between the first electrode and the second electrode. A slope of the side of the groove ranges from 0.2 to 1.5. A horizontal distance ranging from an end of a first transparent electrode of the first electrode or an end of a second transparent electrode of the second electrode to an end of a bottom surface of the groove ranges from 10 μm to 100 μm. The depth of the groove ranges from 5 μm to 30 μm.

The groove may be formed between the first transparent electrode and the second transparent electrode.

A method of manufacturing a plasma display panel according to the embodiments of the present invention comprises forming a first electrode and a second electrode on a substrate, forming a dielectric layer on the first electrode and the second electrode, and forming at least one groove on the dielectric layer between the first electrode and the second electrode.

The forming of the first electrode and the second electrode may comprise forming a first transparent electrode and a second transparent electrode. The groove may be formed between the first transparent electrode and the second transparent electrode.

The dielectric layer may be formed using a dielectric paste or a dielectric dry film.

A distance between the first electrode and the second electrode may range from 10 μm to 200 μm.

The groove may be formed using a pattern printing method.

A slope of the side of the groove may range from 0.2 to 1.5.

The depth of the groove may range from 5 μm to 30 μm.

The forming of the first electrode and the second electrode may comprise forming a first transparent electrode and a second transparent electrode. A horizontal distance from an end of the first transparent electrode or an end of the second transparent electrode to an end of a bottom surface of the groove may range from 10 μm to 100 μm.

Hereinafter, exemplary embodiments of the present invention will be described in detail with reference to the attached drawings.

A plasma display panel according to embodiments of the present invention has a long column structure, in which a distance between a scan electrode and a sustain electrode ranges from 10 μm to 200 μm. A dielectric layer is formed on the scan electrode and the sustain electrode of the plasma display panel according to the embodiments of the present invention. The dielectric layer has a groove.

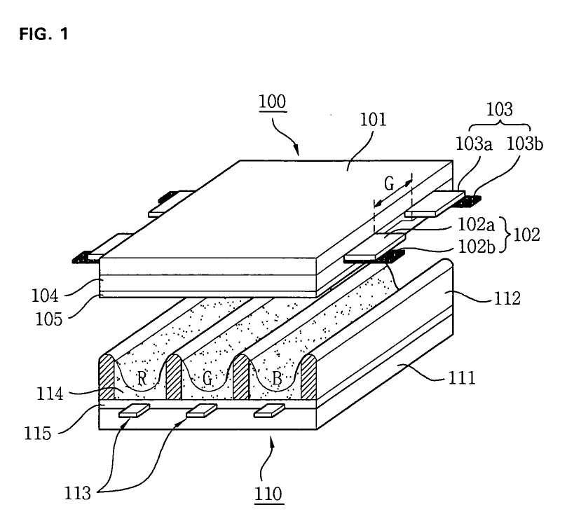

FIG. 1 illustrates a plasma display panel according to an embodiment of the present invention. As illustrated in FIG. 1, the plasma display panel according to the embodiment of the present invention comprises a front panel 100 and a rear panel 110. The front panel 100 on which an image is displayed comprises a front substrate 101. The rear panel 110 comprises a rear substrate 111. A scan electrode 102 and a sustain electrodes 103 are formed on the front substrate 101. An address electrode 113 is formed on the rear substrate 111 to intersect the scan electrode 102 and the sustain electrodes 103.

The scan electrode 102 and the sustain electrode 103 each comprise transparent electrodes 102a and 103a and bus electrodes 102b and 103b. The transparent electrodes 102a and 103a are formed on the front substrate 101, and are made of indium-tin-oxide (ITO). The bus electrodes 102b and 103b are formed on the transparent electrodes 102a and 103a, respectively, and are made of a metal material.

A distance between the transparent electrode 102a of the scan electrode 102 and the transparent electrode 103a of the sustain electrode 103 ranges from 100 μm to 200 μm. When the distance between the transparent electrode 102a of the scan electrode 102 and the transparent electrode 103a of the sustain electrode 103 ranges from 10 μm to 200 μm, a discharge corresponding to positive column is generated in a discharge cell. Accordingly, discharge efficiency of the plasma display panel is improved.

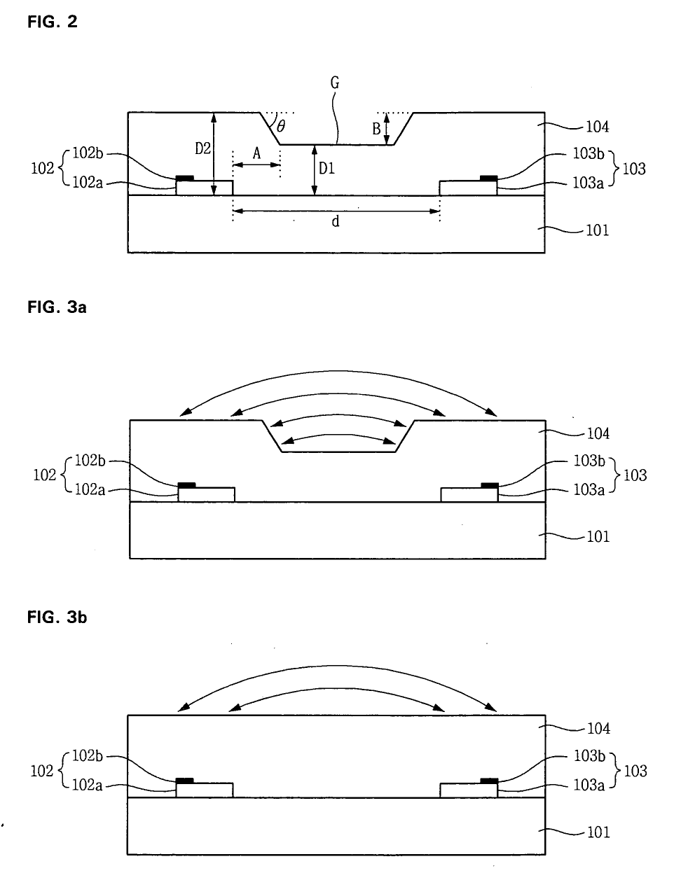

An upper dielectric layer 104 is formed on the scan electrode 102 and the sustain electrode 103. The upper dielectric layer 104 limits a discharge current and provides insulation between the scan electrode 102 and the sustain electrode 103. At least one groove is formed between the transparent electrode 102a of the scan electrode 102 and the transparent electrode 103a of the sustain electrode 103 in the upper dielectric layer 104. The groove formed in the upper dielectric layer 104 will be described in detail with reference to FIG. 2. A protective layer 105 made of MgO is formed on an upper part of the upper dielectric layer 104.

A lower dielectric layer 115 is formed on an upper part of the address electrode 113. Barrier ribs 112 are formed on the lower dielectric layer 115 to form discharge cells. A phosphor layer 114 is formed between the barrier ribs 112. The phosphor layer 114 generates visible light with one of red, green and blue during the generation of the discharge.

FIG. 2 is a cross-sectional view of a front panel of the plasma display panel according to the embodiment of the present invention. As illustrated in FIG. 2, the scan electrode 102 and the sustain electrodes 103 are formed on the front substrate 101. The scan electrode 102 and the sustain electrode 103 each comprise the transparent electrodes 102a and 103a and the bus electrodes 102b and 103b. A distance d between the transparent electrode 102a of the scan electrode 102 and the transparent electrode 103a of the sustain electrode 103 ranges from 10 μm to 200 μm. Accordingly, in the plasma display panel according to the embodiment of the present invention, a discharge corresponding to positive column is generated such that discharge efficiency of the plasma display panel is improved.

A groove G is formed in the upper dielectric layer 104 between the scan electrode 102 and the sustain electrode 103. In FIG. 2, a first distance D1 ranges from the front substrate 101 between the scan electrode 102 and the sustain electrode 103 to the surface of the upper dielectric layer 104. A second distance D2 ranges from the front substrate 101, on which at least one of the scan electrode 102 and the sustain electrode 103 is formed, to the surface of the upper dielectric layer 104. The first distance D1 is less than the second distance D2 due to the groove G.

A slope of the side of the groove G formed in the upper dielectric layer 104 ranges from 0.2 to 1.5. In other words, the tan θ of an angle θ at the side of the groove G ranges from 0.2 to 1.5. A horizontal distance A ranging from an end of the transparent electrode 102a of the scan electrode 102 or an end of the transparent electrode 103a of the sustain electrode 103 to an end of a bottom surface of the groove G ranges from 10 μm to 100 μm . A depth B of the groove G ranges from 5 μm to 30 μm.

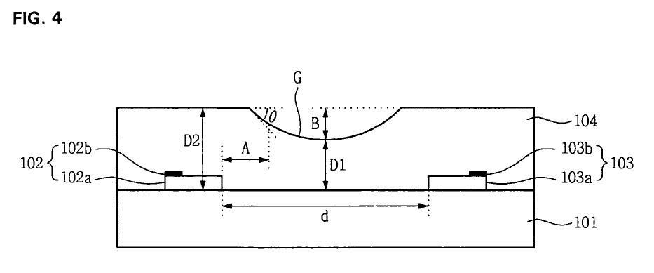

FIGS. 3a and 3b illustrate a comparison between discharge paths of the plasma display panel depending on whether a groove is or not formed in the plasma display panel according to the embodiment of the present invention. FIG. 3a illustrates a discharge path of the plasma display panel when the groove G is formed. FIG. 3b illustrates a discharge path of the plasma display panel when the groove G is not formed. When the slope of the side of the groove G ranges from 0.2 to 1.5, the horizontal distance A ranges from 10 μm to 100 μm, and the depth B of the groove G ranges from 5 μm to 30 μm, the discharge path illustrated in FIG. 3a is shorter than the discharge path illustrated in FIG. 3b. Therefore, a firing start voltage of the plasma display panel decreases. When the distance between the scan electrode 102 and the sustain electrode 103 ranges from 10 μm to 200 μm, the discharge efficiency increases. However, there is a likelihood to increase the firing start voltage. Accordingly, as illustrated in FIG. 3a, when the groove G is formed, the discharge efficiency increases while reducing the firing start voltage.

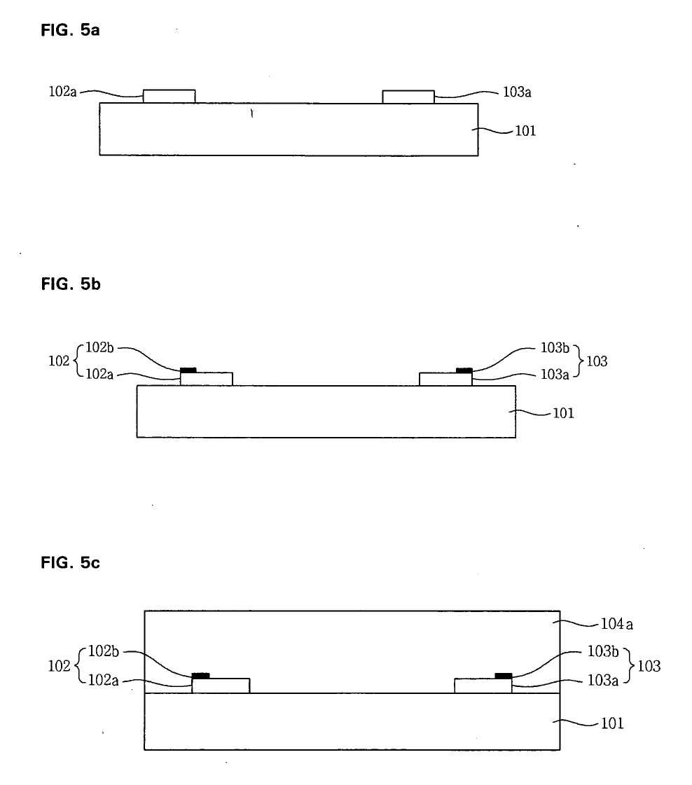

FIG. 4 is a cross-sectional view of a front panel of a plasma display panel according to another embodiment of the present invention. As illustrated in FIG. 4, a distance d between a transparent electrode 102a of a scan electrode 102 and a transparent electrode 103a of a sustain electrode 103 ranges from 10 μm to 200 μm. Accordingly, in the plasma display panel according to another embodiment of the present invention, a discharge corresponding to positive column is generated such that discharge efficiency of the plasma display panel is improved.

A curve-shaped groove G is formed in an upper dielectric layer 104 between the scan electrode 102 and the sustain electrode 103. In FIG. 4, a first distance D1 ranges from a front substrate 101 between the scan electrode 102 and the sustain electrode 103 to the surface of the upper dielectric layer 104. A second distance D2 ranges from the front substrate 101, on which at least one of the scan electrode 102 and the sustain electrode 103 is formed, to the surface of the upper dielectric layer 104. The first distance D1 is less than the second distance D2 due to the groove G.

The tan θ of an angle θ at a curved surface of the groove G ranges from 0.2 to 1.5. A horizontal distance A ranging from an end of the transparent electrode 102a of the scan electrode 102 or an end of the transparent electrode 103a of the sustain electrode 103 to an end of a bottom surface of the groove G ranges from 10 μm to 100 μm. A depth B of the groove G ranges from 5 μm to 30 μm.

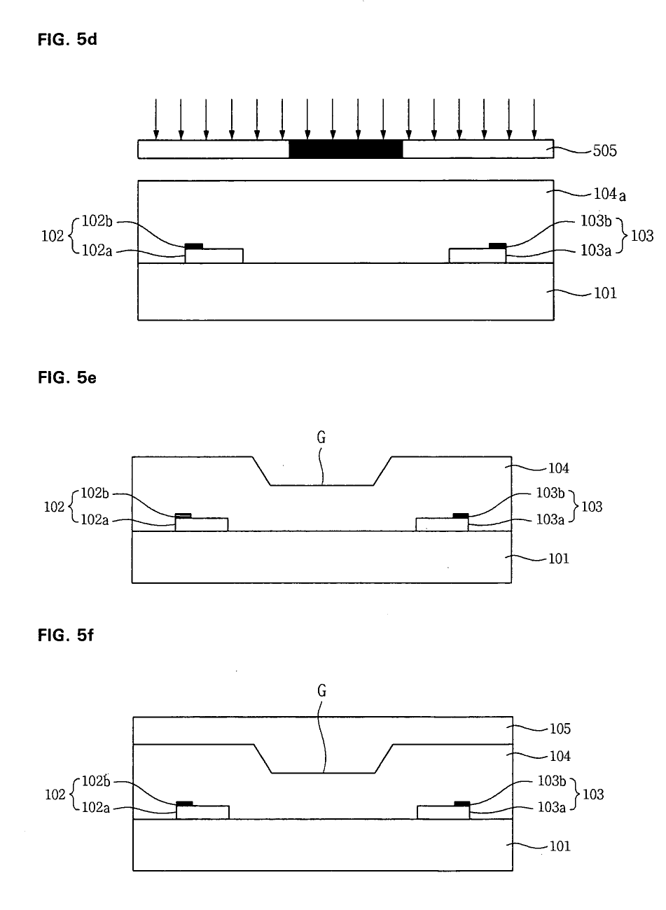

FIGS. 5a to 5f illustrate processes for manufacturing the front panel of the plasma display panel according to the embodiments of the present invention.

As illustrated in FIG. 5a, the transparent electrode 102a of the scan electrode 102 and the transparent electrode 103a of the sustain electrode 103 are formed on the front substrate 101. The distance between the transparent electrode 102a of the scan electrode 102 and the transparent electrode 103a of the sustain electrode 103 ranges from 10 μm to 200 μm.

As illustrated in FIG. 5b, the bus electrodes 102b and 103b are formed on the transparent electrodes 102a and 103a, respectively.

As illustrated in FIG. 5c, a dielectric paste or a dielectric dry film 104a is formed on the upper parts of the scan electrode 102 and the sustain electrode 103. Then, as illustrated in FIG. 5d, a pattern of the groove G is formed on the dielectric paste or the dielectric dry film 104a using a mask 505 for performing a pattern printing method

As illustrated in FIG. 5e, an etching process is performed to form the groove G on the dielectric paste or the dielectric dry film 104a. A firing process is performed at a temperature of about 500 □ to about 600 □ to form the upper dielectric layer 104. A slope of the side of the groove G f ranges from 0.2 to 1.5. The horizontal distance A ranging from the end of the transparent electrode 102a of the scan electrode 102 or the end of the transparent electrode 103a of the sustain electrode 103 to the end of the bottom surface of the groove G ranges from 10 μm to 100 μm. The depth of the groove G ranges from 5 μm to 30 μm.

As illustrated in FIG. 5f, the protective layer 105 made of MgO is formed on the upper part of the upper dielectric layer 104.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a substrate;
a first electrode and a second electrode formed on the substrate, a distance between the first electrode and the second electrode ranging 10 μm to 200 μm; and
a dielectric layer formed on the first electrode and the second electrode, wherein a first distance ranging from the substrate between the first electrode and the second electrode to the surface of the dielectric layer is different from a second distance ranging from the substrate, on which at least one of the first electrode and the second electrode is formed, to the surface of the dielectric layer.

2. The plasma display panel of claim 1, wherein the first distance is less than the second distance.

3. A plasma display panel comprising:
a substrate;
a first electrode and a second electrode formed on the substrate, a distance between the first electrode and the second electrode ranging 10 μm to 200 μm; and
a dielectric layer, formed on the first electrode and the second electrode, comprising at least one groove formed between the first electrode and the second electrode.

4. The plasma display panel of claim 3, wherein a slope of the side of the groove ranges from 0.2 to 1.5.

5. The plasma display panel of claim 3, wherein the first electrode comprises a first transparent electrode, and the second electrode comprises a second transparent electrode, and a horizontal distance ranging from an end of the first transparent electrode or an end of the second transparent electrode to an end of a bottom surface of the groove ranges from 10 μm to 100 μm.

6. The plasma display panel of claim 3, wherein the depth of the groove ranges from 5 μm to 30 μm.

7. A plasma display panel comprising:
a substrate;
a first electrode and a second electrode formed on the substrate; and
a dielectric layer, formed on the first electrode and the second electrode, comprising at least one groove formed between the first electrode and the second electrode,
wherein a slope of the side of the groove ranges from 0.2 to 1.5,
a horizontal distance ranging from an end of a first transparent electrode of the first electrode or an end of a second transparent electrode of the second electrode to an end of a bottom surface of the groove ranges from 10 μm to 100 μm, and the depth of the groove ranges from 5 μm to 30 μm.

8. The plasma display panel of claim 7, wherein the groove is formed between the first transparent electrode and the second transparent electrode.

9. A method of manufacturing a plasma display panel comprising:
forming a first electrode and a second electrode on a substrate;
forming a dielectric layer on the first electrode and the second electrode; and
forming at least one groove on the dielectric layer between the first electrode and the second electrode.

10. The method of claim 9, wherein the forming of the first electrode and the second electrode comprises forming a first transparent electrode and a second transparent electrode, and the groove is formed between the first transparent electrode and the second transparent electrode.

11. The method of claim 9, wherein the dielectric layer is formed using a dielectric paste or a dielectric dry film.

12. The method of claim 9, wherein a distance between the first electrode and the second electrode ranges from 10 μm to 200 μm.

13. The method of claim 9, wherein the groove is formed using a pattern printing method.

14. The method of claim 9, wherein a slope of the side of the groove ranges from 0.2 to 1.5.

15. The method of claim 9, wherein the depth of the groove ranges from 5 μm to 30 μm.

16. The method of claim 9, wherein the forming of the first electrode and the second electrode comprises forming a first transparent electrode and a second transparent electrode, and
a horizontal distance from an end of the first transparent electrode or an end of the second transparent electrode to an end of a bottom surface of the groove ranges from 10 μm to 100 μm.
